(19) United States
(12) Patent Application Publication
(10) Pub. No.: US 2024/0162533 A1
(43) Pub. Date: May 16, 2024

(54) SOLID-STATE BATTERY AND METHOD OF MANUFACTURING SOLID-STATE BATTERY

(71) Applicant: TOYOTA JIDOSHA KABUSHIKI KAISHA, Toyota-shi (JP)

(72) Inventor: Yushi SUZUKI, Mishima-shi (JP)

(73) Assignee: TOYOTA JIDOSHA KABUSHIKI KAISHA, Toyota-shi (JP)

(21) Appl. No.: 18/238,248

(22) Filed: Aug. 25, 2023

(30) Foreign Application Priority Data
Nov. 10, 2022 (JP) 2022-180449

(51) Int. Cl. H01M 4/66; H01M 4/04

(52) U.S. Cl. CPC H01M 4/667; H01M 4/0404

(57) ABSTRACT

A solid-state battery having a first current collector layer, a first active material layer, a solid electrolyte layer, a second active material layer, and a second current collector layer in order as stated is provided. The first current collector layer and the second current collector layer have extended portions, the first current collector layer and the second current collector layer are joined to each other via a thermoplastic resin layer between the extended portions thereof, and (i) an extended portion of the solid electrolyte layer and the second current collector layer are joined to each other via the thermoplastic resin layer or (ii) an extended portion of the first active material layer and the second current collector layer are joined to each other via the thermoplastic resin layer.

### CROSS-REFERENCE TO RELATED APPLICATION

This application claims priority to Japanese Patent Application No. 2022-180449 filed on Nov. 10, 2022, incorporated herein by reference in its entirety.

### BACKGROUND

### 1. Technical Field

The present disclosure relates to a solid-state battery and a method of manufacturing the solid-state battery.

### 2. Description of Related Art

In recent years, various structures for a layer-built battery, in particular, a thin layer-built battery and a method of manufacturing the same are being proposed (Japanese Unexamined Patent Application Publication No. 2006-278141, Japanese Unexamined Patent Application Publication No. 2017-220447, and Japanese Unexamined Patent Application Publication No. 2005-129913).

For example, JP 2017-220447 A discloses a method of manufacturing an all-solid-state battery including: a first step of obtaining a layer-built battery including both end surfaces in a layered direction and a side surface by layering each of a current collector layer, a positive-electrode mixture layer, a solid electrolyte layer, and a negative-electrode mixture layer by a plurality of numbers; a second step of supplying a liquid resin to only the side surface of the layer-built battery; and a third step of curing the liquid resin. In the method, the first step includes causing at least one layer out of the current collector layer, the positive-electrode mixture layer, the solid electrolyte layer, and the negative-electrode mixture layer to be an extended layer by extending the at least one layer relative to other layers, and extending a plurality of the extended layers on the side surface of layer-built battery, and the second step includes causing the liquid resin to enter a gap between one extended layer and another extended layer by supplying the liquid resin to only the side surface of the layer-built battery.

### SUMMARY

As described above, various structures for a layer-built battery, in particular, a thin layer-built battery and a method of manufacturing the same are being proposed, but a new layer-built battery is further required depending on the usage.

Meanwhile, in the present disclosure, a new layer-built solid-state battery, in particular, a thin solid-state battery and a method of manufacturing the same are provided.

As a result of keen examination, the inventors of the present disclosure have found that the problem described above can be solved by the following means and have completed the present disclosure. In other words, the present disclosure is as follows:

### Aspect 1

A solid-state battery including a first current collector layer, a first active material layer, a solid electrolyte layer, a second active material layer, and a second current collector layer in order as stated. In the solid-state battery:
the first current collector layer and the second current collector layer each have an extended portion that extends to the outer circumferential side relative to the first active material layer, the solid electrolyte layer, and the second active material layer over the entire circumference of the first active material layer, the solid electrolyte layer, and the second active material layer;
the first current collector layer and the second current collector layer are joined to each other via a thermoplastic resin layer between the extended portions; and
(i) the first active material layer and the solid electrolyte layer have an extended portion that extends to the outer circumferential side relative to the second active material layer over the entire circumference of the second active material layer, and the extended portion of the solid electrolyte layer and the second current collector layer are joined to each other via the thermoplastic resin layer or (ii) the first active material layer has an extended portion that extends to the outer circumferential side relative to the second active material layer and the solid electrolyte layer over the entire circumference of the second active material layer and the solid electrolyte layer, and the extended portion of the first active material layer and the second current collector layer are joined to each other via the thermoplastic resin layer.

### Aspect 2

The solid-state battery according to Aspect 1. In the solid-state battery, the thickness from an outer side surface of the first current collector layer to an outer side surface of the second current collector layer in the layered direction may be 0.05 mm or more and 2.0 mm or less.

### Aspect 3

The solid-state battery according to Aspect 1 or 2. In the solid-state battery:
the first current collector layer, the first active material layer, the solid electrolyte layer, the second active material layer, and the second current collector layer may be sealed by a first insulation film layered on the outer side surface of the first current collector layer and a second insulation film layered on the outer side surface of the second current collector layer;
the thermoplastic resin layer may have an extended portion that extends to the outer circumferential side relative to the first current collector layer and the second current collector layer over the entire circumference of the first current collector layer and the second current collector layer;
a first collector tab layered on the outer side surface of the first current collector layer or a protruding portion of the first current collector layer may protrude from the first and second insulation films so as to exceed the extended portion of the thermoplastic resin layer;
a second collector tab layered on the outer side surface of the second current collector layer or a protruding portion of the second current collector layer may protrude from the first and second insulation films so as to exceed the extended portion of the thermoplastic resin layer; and the first collector tab or the protruding portion of the first current collector layer and the second collector tab or the protruding portion of the second current collector layer may be insulated from each other by being offset from each other in a plane direction of the solid-state battery.

### Aspect 4

A method of manufacturing the solid-state battery according to any one of Aspects 1 to 3, the method including:
forming an unsealed solid-state battery by layering the first current collector layer, the first active material layer, the solid electrolyte layer, the second active material layer, and the second current collector layer in order as stated while disposing a thermoplastic resin annular sealing member between the extended portion of the first current collector layer and the extended portion of the second current collector layer over the entire circumference of the extended portion of the first current collector layer and the extended portion of the second current collector layer; and
forming the thermoplastic resin layer by causing the thermoplastic resin annular sealing member to flow to at least an inner-circumferential-side space of the thermoplastic resin annular sealing member by heating-pressing the unsealed solid-state battery in a state in which the air pressure of the inner-circumferential-side space is lower than the air pressure of an outer-circumferential-side space of the thermoplastic resin annular sealing member.

### Aspect 5

The method according to Aspect 4. The method may further include forming the thermoplastic resin layer by causing the thermoplastic resin annular sealing member to flow to at least the inner circumferential side by heating-pressing the unsealed solid-state battery in a state in which the air pressure of the inner-circumferential-side space of the thermoplastic resin annular sealing member is equal to or less than the atmospheric pressure.

According to the present disclosure, the new layer-built solid-state battery, in particular, the thin layer-built solid-state battery and the method of manufacturing the same are provided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a schematic cross-sectional view showing two aspects of a solid-state battery of the present disclosure;

FIG. 1B is a schematic cross-sectional view showing two aspects of the solid-state battery of the present disclosure;

FIG. 2A is a schematic cross-sectional view showing one aspect of the solid-state battery of the present disclosure;

FIG. 2B is a schematic upper view showing two aspects of the solid-state battery of the present disclosure;

FIG. 2C is a schematic upper view showing two aspects of the solid-state battery of the present disclosure;

FIG. 3A is a schematic cross-sectional view showing a method of manufacturing the solid-state battery of the present disclosure shown in FIG. 1A;

FIG. 3B is a schematic cross-sectional view showing the method of manufacturing the solid-state battery of the present disclosure shown in FIG. 1A;

FIG. 3C is a schematic cross-sectional view showing the method of manufacturing the solid-state battery of the present disclosure shown in FIG. 1A;

FIG. 3D is a schematic cross-sectional view showing the method of manufacturing the solid-state battery of the present disclosure shown in FIG. 1A; and

FIG. 3E is a schematic cross-sectional view showing the method of manufacturing the solid-state battery of the present disclosure shown in FIG. 1A.

### DETAILED DESCRIPTION OF EMBODIMENTS

A mode for carrying out the present disclosure is described in detail below with reference to the drawings. However, the mode shown in the drawings is an exemplification of the present disclosure and does not limit the present disclosure.

### Solid-state Battery

A solid-state battery of the present disclosure includes a first current collector layer, a first active material layer, a solid electrolyte layer, a second active material layer, and a second current collector layer in order as stated. The first current collector layer and the second current collector layer each have an extended portion that extends to the outer circumferential side relative to the first active material layer, the solid electrolyte layer, and the second active material layer over the entire circumference of the first active material layer, the solid electrolyte layer, and the second active material layer, and the first current collector layer and the second current collector layer are joined to each other via a thermoplastic resin layer between the extended portions. In the solid-state battery of the present disclosure, (i) the first active material layer and the solid electrolyte layer have an extended portion that extends to the outer circumferential side relative to the second active material layer over the entire circumference of the second active material layer, and the extended portion of the solid electrolyte layer and the second current collector layer are joined to each other via the thermoplastic resin layer or (ii) the first active material layer has an extended portion that extends to the outer circumferential side relative to the second active material layer and the solid electrolyte layer over the entire circumference of the second active material layer and the solid electrolyte layer, and the extended portion of the first active material layer and the second current collector layer are joined to each other via the thermoplastic resin layer.

According to the solid-state battery of the present disclosure as above, a high structural stability of the solid electrolyte layer and the active material layer can be provided because the extended portion of the solid electrolyte layer and the second current collector layer are joined to each other via the thermoplastic resin layer ((i) described above) or the extended portion of the first active material layer and the second current collector layer are joined to each other via the thermoplastic resin layer ((ii) described above).

According to the solid-state battery of the present disclosure as above, the space of a circumferential edge portion for sealing can be reduced, and hence the energy density can be increased. According to the solid-state battery of the present disclosure as above, the joining and sealing between the layers are performed with use of the thermoplastic resin layer. Therefore, manufacturing is easy, and there is high degree of freedom regarding material selection.

The solid-state battery of the present disclosure as above can have a relatively thin thickness. For example, the thickness from the outer side surface of the first current collector layer to the outer side surface of the second current collector layer in the layered direction may be 0.01 mm or more, 0.05 mm or more, 0.10 mm or more, 0.50 mm or more, or 1.00 mm or more and may be 5.00 mm or less, 4.00 mm or less, 3.00 mm or less, 2.00 mm or less, 1.50 mm or less, or 1.00 mm or less.

The solid-state battery of the present disclosure as above can have a freely-selected shape in the plane direction of the solid-state battery and can have a shape of a circular shape or a polygonal shape (a triangular shape, a quadrilateral shape, or a hexagonal shape), for example.

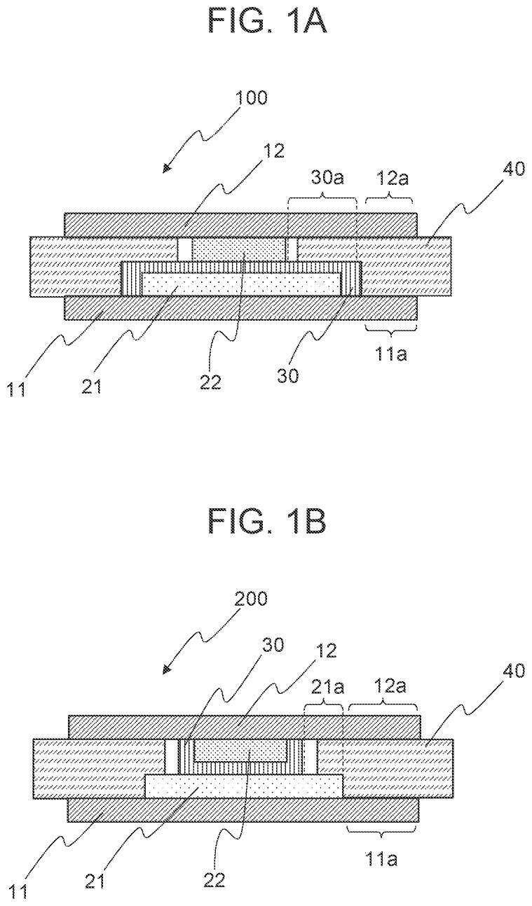

In one aspect, the solid-state battery of the present disclosure can have a structure shown in FIG. 1A, for example. Specifically, as shown in FIG. 1A, a solid-state battery 100 of the present disclosure has a first current collector layer 11, a first active material layer 21, a solid electrolyte layer 30, a second active material layer 22, and a second current collector layer 12 in order as stated. The first current collector layer 11 and the second current collector layer 12 have extended portions 11a, 12a that extend to the outer circumferential side relative to the first active material layer 21, the solid electrolyte layer 30, and the second active material layer 22 over the entire circumference of the first active material layer 21, the solid electrolyte layer 30, and the second active material layer 22. The first current collector layer 11 and the second current collector layer 12 are joined to each other via a thermoplastic resin layer 40 between the extended portions 11a, 12a. In the solid-state battery of the present disclosure, (i) the first active material layer 21 and the solid electrolyte layer 30 have an extended portion 30a that extends to the outer circumferential side relative to the second active material layer 22 over the entire circumference of the second active material layer 22, and the extended portion 30a of the solid electrolyte layer and the second current collector layer 12 are joined to each other via the thermoplastic resin layer 40.

The solid-state battery of the present disclosure can have a structure shown in FIG. 1B, for example, in another aspect. Specifically, as shown in FIG. 1B, a solid-state battery 200 of the present disclosure has the first current collector layer 11, the first active material layer 21, the solid electrolyte layer 30, the second active material layer 22, and the second current collector layer 12 in order as stated. The first current collector layer 11 and the second current collector layer 12 have the extended portions 11a, 12a that extend to the outer circumferential side relative to the first active material layer 21, the solid electrolyte layer 30, and the second active material layer 22 over the entire circumference of the first active material layer 21, the solid electrolyte layer 30, and the second active material layer 22. The first current collector layer 11 and the second current collector layer 12 are joined to each other via a thermoplastic resin layer 40 between the extended portions 11a, 12a. In the solid-state battery of the present disclosure, (ii) the first active material layer 21 has an extended portion 21a that extends to the outer circumferential side relative to the second active material layer 22 and the solid electrolyte layer 30 over the entire circumference of the second active material layer 22 and the solid electrolyte layer 30, and the extended portion 21a of the first active material layer 21 and the second current collector layer 12 are joined to each other via the thermoplastic resin layer 40.

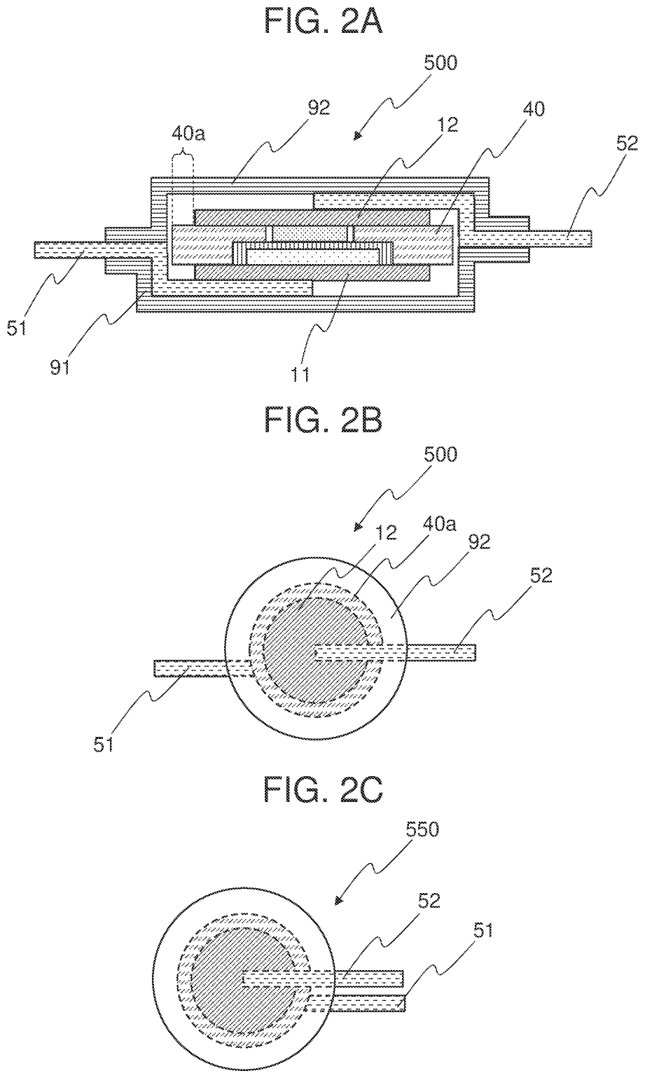

In a solid-state battery 500 of the present disclosure, as shown in FIG. 2A and FIG. 2B, the first current collector layer 11, the first active material layer 21, the solid electrolyte layer 30, the second active material layer 22, and the second current collector layer 12 may be sealed by a first insulation film 91 layered on an outer side surface of the first current collector layer 11 and a second insulation film 92 layered on an outer side surface of the second current collector layer 12. In the solid-state battery 500 of the present disclosure, the thermoplastic resin layer 40 has an extended portion 40a that extends to the outer circumferential side relative to the first current collector layer 11 and the second current collector layer 12 over the entire circumference of the first current collector layer 11 and the second current collector layer 12. A first collector tab 51 is layered on the outer side surface of the first current collector layer 11, and the first collector tab 51 protrudes from the first and second insulation films 91, 92 so as to exceed the extended portion 40a of the thermoplastic resin layer 40. A second collector tab 52 is layered on the outer side surface of the second current collector layer 12, and the second collector tab 52 protrudes from the first and second insulation films 91, 92 so as to exceed the extended portion 40a of the thermoplastic resin layer 40. The first collector tab 51 and the second collector tab 52 are insulated from each other by being offset (shifted) from each other in the plane direction of the solid-state battery 500.

In the aspect shown in FIG. 2A and FIG. 2B, the first collector tab 51 and the second collector tab 52 protrude from the first and second insulation films 91, 92 so as to exceed the extended portion 40a of the thermoplastic resin layer 40 in opposite directions. However, as shown in FIG. 2C, the first collector tab 51 and the second collector tab 52 may protrude from the first and second insulation films 91, 92 so as to exceed the extended portion 40a of the thermoplastic resin layer 40 to be offset from each other in the plane direction of the solid-state battery 500 in the same direction.

In the aspect shown in FIG. 2A, FIG. 2B, FIG. 2C, the first and second collector tabs respectively layered on the outer side surfaces of the first and second current collector layers protrude from the first and second insulation films. However, the collector tabs as above do not necessarily need to be used, and the protruding portions of the first and second current collector layers may protrude from the first and second insulation instead.

The solid-state battery of the present disclosure may be a battery that uses freely-selected ions as charge carriers and may be a lithium ion battery, a sodium ion battery, a magnesium ion battery, and a calcium ion battery, for example. Out of the above, the solid-state battery of the present disclosure is preferred to be a lithium ion battery and a sodium ion battery and is particularly preferred to be a lithium ion battery.

The solid-state battery of the present disclosure is preferably a sulfide solid-state battery, in other words, a solid-state battery in which at least one of the positive-electrode layer, the solid electrolyte layer, and the negative-electrode layer configuring the battery contains a sulfide solid-state electrolyte. The solid-state battery of the present disclosure may be a lithium ion sulfide solid-state battery, a sodium ion sulfide solid-state battery, a magnesium ion sulfide solid-state battery, and a calcium ion sulfide solid-state battery. Out of the above, the solid-state battery of the present disclosure is preferred to be a lithium ion sulfide solid-state battery and a sodium ion sulfide solid-state battery and is particularly preferred to be a lithium ion sulfide solid-state battery.

A sulfide solid-state layer-built battery of the present disclosure may be a primary battery or may be a secondary battery but is preferably a secondary battery. Therefore, the sulfide solid-state layer-built battery of the present disclosure is preferably a lithium ion sulfide solid-state secondary battery.

In the solid-state battery of the present disclosure, in one aspect, the first current collector layer can be a negative-electrode current collector layer, the first active material layer can be a negative-electrode active material layer, the second active material layer can be a positive-electrode active material layer, and the second current collector layer can be a positive-electrode current collector layer. In the solid-state battery of the present disclosure, in another aspect, the first current collector layer can be a positive-electrode current collector layer, the first active material layer can be a positive-electrode active material layer, the second active material layer can be a negative-electrode active material layer, and the second current collector layer can be a negative-electrode current collector layer.

In the solid-state battery of the present disclosure, layers of freely-selected materials and particularly layers of freely-selected known materials can be used as the negative-electrode current collector layer, the negative-electrode active material layer, the solid electrolyte layer, the positive-electrode active material layer, the positive-electrode current collector layer, and the thermoplastic resin layer.

Therefore, for example, as the thermoplastic resin layer, a layer of polyethylene, polypropylene, polyvinyl chloride, polyvinylidene chloride, polystyrene, polyvinyl acetate, polyamide, polycarbonate or the like can be used. In particular, a layer of an olefin-based polymer, for example, polyethylene or polypropylene can be used as the thermoplastic resin layer.

At least one of the negative-electrode active material layer, the solid electrolyte layer, and the positive-electrode active material layer can have a solid-state electrolyte, particularly a sulfide-based solid-state electrolyte and/or an oxide-based solid-state electrolyte, and more particularly a sulfide-based solid-state electrolyte. In general, the solid-state electrolyte is relatively high in terms of thermal resistance, and hence can withstand heat-pressing when the solid-state battery of the present disclosure is manufactured by a method of the present disclosure.

The solid electrolyte layer used in the solid-state battery of the present disclosure may have a liquid electrolyte in addition to the solid-state electrolyte.

### Method of Manufacturing Solid-state Battery

The solid-state battery of the present disclosure can be manufactured by a freely-selected manufacturing method and can be manufactured by the method of the present disclosure, for example.

The manufacturing method of the present disclosure of manufacturing the solid-state battery of the present disclosure includes:
forming an unsealed solid-state battery by layering the first current collector layer, the first active material layer, the solid electrolyte layer, the second active material layer, and the second current collector layer in order as stated while disposing a thermoplastic resin annular sealing member between the extended portion of the first current collector layer and the extended portion of the second current collector layer over the entire circumference of the extended portion of the first current collector layer and the extended portion of the second current collector layer; and
forming the thermoplastic resin layer by causing the thermoplastic resin annular sealing member to flow to at least the inner circumferential side by heat-pressing the unsealed solid-state battery in a state in which the air pressure of an inner-circumferential-side space of the thermoplastic resin annular sealing member is lower than the air pressure of an outer-circumferential-side space of the thermoplastic resin annular sealing member.

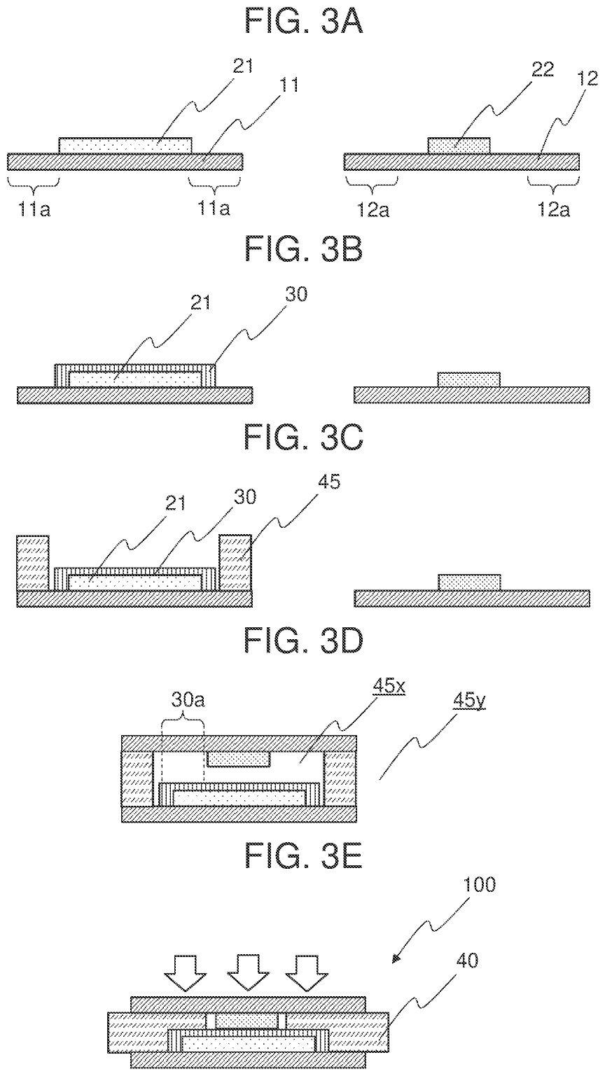

For example, the solid-state battery of the present disclosure shown in FIG. 1A can be manufactured by a method shown in FIG. 3A, FIG. 3B, FIG. 3C, FIG. 3D, and FIG. 3E.

Specifically, in the method shown in FIG. 3A, FIG. 3B, FIG. 3C, FIG. 3D, FIG. 3E, the first current collector layer 11 and the first active material layer 21 on the first current collector layer 11 are provided, and the second current collector layer 12 and the second active material layer 21 on the second current collector layer 12 are provided first as shown in FIG. 3A. The first current collector layer 11 and the second current collector layer 12 have the extended portions 11a, 12a, respectively.

Next, as shown in FIG. 3B, an upper surface and optionally side surfaces of the first active material layer 21 are covered with the solid electrolyte layer 30.

Next, as shown in FIG. 3C, the thermoplastic resin annular sealing member is disposed on the first current collector layer 11 so as to surround the first active material layer 21 and the solid electrolyte layer 30. The thermoplastic resin annular sealing member may be a free-standing film-like member or may be a coating film formed by the application of a resin solution onto the first current collector layer 11.

Next, as shown in FIG. 3D, the first current collector layer 11, the first active material layer 21, the solid electrolyte layer 30, the second active material layer 22, and the second current collector layer 12 are layered in order as stated such that the thermoplastic resin annular sealing member 45 is disposed between the extended portion 11a of the first current collector layer 11 and the extended portion 12a of the second current collector layer 12 over the entire circumference of the extended portion 11a of the first current collector layer 11 and the extended portion 12a of the second current collector layer 12. As a result, the unsealed solid-state battery is formed.

Next, as shown in FIG. 3D and FIG. 3E, in a state in which the air pressure of an inner-circumferential-side space 45x of the thermoplastic resin annular sealing member 45 is lower than the air pressure of an outer-circumferential-side space 45y of the thermoplastic resin sealing member 45, the unsealed solid-state battery heating-pressed (arrows), and the thermoplastic resin annular sealing member 45 is caused to flow to at least the inner-circumferential-side space 45x. As a result, the thermoplastic resin layer 40 is formed. In particular, it is possible to form the thermoplastic resin layer 40 by causing the thermoplastic resin annular sealing member 45 to flow to at least the inner-circumferential-side space 45x by heating-pressing the unsealed solid-state battery in a state in which the air pressure of the inner-circumferential-side space 45x of the thermoplastic resin annular sealing member 45 is equal to or less than atmospheric pressure. The heating-pressing can be performed at a freely-selected temperature and a freely-selected pressure with which the thermoplastic resin layer can be formed. For example, the heating-pressing can be performed with use of a temperature in a range of 100° C. to 200° C. and a pressure of 0.1 MPa to 500 MPa, for example, 0.1 MPa to 100 MPa, 0.1 MPa to 10 MPa, or 0.1 MPa to 5 MPa.

In the aspect shown in FIG. 3A, FIG. 3B, FIG. 3C, FIG. 3D, and FIG. 3E, a solid-state battery of an example was generated where the first current collector layer 11 is the negative-electrode current collector layer, the first active material layer 21 is the negative-electrode active material layer, the second active material layer 22 is the positive-electrode active material layer, and the second current collector layer 12 is the positive-electrode current collector layer.

Specifically, components of each active material layer, the solid electrolyte layer, and each current collector layer were as follows:
Positive-electrode active material layer: a mixture of a positive-electrode active material (lithium nickel manganese cobalt oxide), a solid-state electrolyte (LiI—LiBr—Li₂S—P₂S₅), a conductive assistant agent (vapor grown carbon fiber), and a binder (styrene butylene rubber)
Negative-electrode active material layer: a mixture of a negative-electrode active material (graphite), a solid-state electrolyte (LiI—LiBr—Li₂S—P₂S₅), and a binder (styrene butylene rubber)
Solid electrolyte layer: a mixture of a solid-state electrolyte (LiI—LiBr—Li₂S—P₂S₅) and a binder (styrene butylene rubber)
Positive-electrode current collector layer: aluminum foil
Negative-electrode current collector layer: nickel foil
Thermoplastic resin annular sealing member: polypropylene film

In the manufacturing of the positive-electrode active material layer and the negative-electrode active material layer, the positive-electrode current collector layer and the negative-electrode current collector layer were pattern-coated with the components dispersed in a solvent (heptyl butyrate). In the manufacturing of the solid electrolyte layer, pattern coating was performed so as to cover the negative-electrode active material layer with the components dispersed in a solvent (heptyl butyrate).

The unsealed solid-state battery obtained as shown in FIG. 3A, FIG. 3B, FIG. 3C, FIG. 3D, and FIG. 3E was heated for two minutes at 160° C. and was heating-pressed (0.5 MPa) for one minute in a reduced-pressure atmosphere (1.4 kPa).

The obtained battery of the example was able to be charged and discharged. When the cross-section of the obtained battery of the example was observed, the first current collector layer and the second current collector layer were joined to each other via the thermoplastic resin layer between the extended portions thereof, and the extended portion of the solid electrolyte layer and the second current collector layer were joined to each other via the thermoplastic resin layer.

What is claimed is:

1. A solid-state battery, including a first current collector layer, a first active material layer, a solid electrolyte layer, a second active material layer, and a second current collector layer in order as stated, wherein:
the first current collector layer and the second current collector layer each have an extended portion that extends to an outer circumferential side relative to the first active material layer, the solid electrolyte layer, and the second active material layer over an entire circumference of the first active material layer, the solid electrolyte layer, and the second active material layer;
the first current collector layer and the second current collector layer are joined to each other via a thermoplastic resin layer between the extended portions; and
(i) the first active material layer and the solid electrolyte layer have an extended portion that extends to the outer circumferential side relative to the second active material layer over the entire circumference of the second active material layer, and the extended portion of the solid electrolyte layer and the second current collector layer are joined to each other via the thermoplastic resin layer or (ii) the first active material layer has an extended portion that extends to the outer circumferential side relative to the second active material layer and the solid electrolyte layer over the entire circumference of the second active material layer and the solid electrolyte layer, and the extended portion of the first active material layer and the second current collector layer are joined to each other via the thermoplastic resin layer.

2. The solid-state battery according to claim 1, wherein a thickness from an outer side surface of the first current collector layer to an outer side surface of the second current collector layer in a layered direction is 0.05 mm or more and 2.0 mm or less.

3. The solid-state battery according to claim 1, wherein:
the first current collector layer, the first active material layer, the solid electrolyte layer, the second active material layer, and the second current collector layer are sealed by a first insulation film layered on the outer side surface of the first current collector layer and a second insulation film layered on the outer side surface of the second current collector layer;
the thermoplastic resin layer has an extended portion that extends to the outer circumferential side relative to the first current collector layer and the second current collector layer over the entire circumference of the first current collector layer and the second current collector layer;
a first collector tab layered on the outer side surface of the first current collector layer or a protruding portion of the first current collector layer protrude from the first and second insulation films so as to exceed the extended portion of the thermoplastic resin layer;
a second collector tab layered on the outer side surface of the second current collector layer or a protruding portion of the second current collector layer protrude from the first and second insulation films so as to exceed the extended portion of the thermoplastic resin layer; and
the first collector tab or the protruding portion of the first current collector layer and the second collector tab or the protruding portion of the second current collector layer are insulated from each other by being offset from each other in a plane direction of the solid-state battery.

4. A method of manufacturing the solid-state battery according to claim 1, the method comprising:
forming an unsealed solid-state battery by layering the first current collector layer, the first active material layer, the solid electrolyte layer, the second active material layer, and the second current collector layer in order as stated while disposing a thermoplastic resin annular sealing member between the extended portion of the first current collector layer and the extended portion of the second current collector layer over an entire circumference of the extended portion of the first current collector layer and the extended portion of the second current collector layer; and
forming the thermoplastic resin layer by causing the thermoplastic resin annular sealing member to flow to at least an inner-circumferential-side space of the thermoplastic resin annular sealing member by heating-pressing the unsealed solid-state battery in a state in which an air pressure of the inner-circumferential-side space is lower than an air pressure of an outer-circumferential-side space of the thermoplastic resin annular sealing member.

5. The method according to claim 4, further comprising forming the thermoplastic resin layer by causing the thermoplastic resin annular sealing member to flow to at least the inner circumferential side by heating-pressing the unsealed solid-state battery in a state in which an air pressure of the inner-circumferential-side space of the thermoplastic resin annular sealing member is equal to or less than an atmospheric pressure.
